(19) United States
(12) Patent Application Publication
(10) Pub. No.: US 2025/0022046 A1
(43) Pub. Date: Jan. 16, 2025

(54) AUCTION SYSTEM AND METHOD

(71) Applicant: Vitaliy Grigorov, Bondi Junction (AU)

(72) Inventor: Vitaliy Grigorov, Bondi Junction (AU)

(21) Appl. No.: 18/349,914

(22) Filed: Jul. 10, 2023

(51) Int. Cl. G06Q 30/08; G06Q 20/38

(52) U.S. Cl. CPC G06Q 30/08; G06Q 20/389

(57) ABSTRACT

An auction system includes a plurality of participant devices and an auctioneer device. The participant devices correspond to a plurality of participants and are configured to receive auction information input by a participant and to display auction information to a participant. The auctioneer device is configured to process the auction information received from the plurality of participant devices, to determine an instant profit value upon receiving bid purchases from participants, and to record ownership of the auction item to the participants that provide the bid purchases.

### BACKGROUND

### Field of the Invention

This disclosure generally relates to auctions, and in particular relates to an auction system and method having successive temporary holding right or ownership interests passing from a current bidder/owner to a subsequent bidder/owner upon the subsequent owner providing a bid purchase.

### Scope of the Prior Art:

An auction typically comprises one seller, multiple bidders and one eventual buyer that pays a final price for the item being auctioned. For example, in an English auction, an auctioneer starts the bidding process by presenting and announcing a first price set by the seller. Bidding increases progressively until demand falls, at which time a winning bidder is determined and the winning bidder pays the highest valuation achieved.

The English auction may also be subject to an auction time period that limits the duration of the auction. Often the number of bids increases as the expiration of the time period approaches, which also results in a winning bidder paying the highest valuation achieved. Traditional auctions, however, do not typically provide an incentive for participants other than the possibility of obtaining the winning bid.

### SUMMARY

Disclosed herein is an auction system and method that, in one example embodiment, is based on an ownership interest that passes with each successive bid purchase to provide a purchasing incentive. The auction system and method may be subject to an auction instrument, such as a contract, a click wrap agreement, smart contract, and the like, through which an initial seller is obligated to sell an auction item to a first purchaser upon the first purchaser issuing a first bid purchase. Thereafter, the first purchaser is obligated to sell the auction item to a second purchaser upon the second purchaser issuing a second bid purchase. Subsequent purchasers are likewise obligated through this instrument to sell the auction item to further subsequent purchasers upon the further subsequent purchasers issuing further subsequent bid purchases until the auction ends, i.e., the price set by seller is achieved; the seller stops the auction and the product goes to the highest bidder.

Also disclosed herein is an auction system that, in one example embodiment, includes a plurality of participant devices and an auctioneer device. The plurality of participant devices correspond to a plurality of participants, and each participant device is configured to receive auction information input by a participant and to display auction information to a participant. The auction information includes a post of an auction item for sale by a participant at an initial selling price and bid purchases from the plurality of participants. The auctioneer device is in data communication with the plurality of participant devices over a network, and is configured to process the auction information received from the plurality of participant devices to determine an instant profit value upon receiving a bid purchase from a participant. The instant profit value is based on the value of the bid purchase. The auctioneer device is also configured to manage participant accounts, to credit participant accounts with the instant profit value for the participants and to record temporary holding right of the auction item to the participant that provides a bid purchase upon determining the instant profit value, and to process successive bid purchases for the auction item until the expiration of an auction time.

Also disclosed herein is an auction method for selling an auction item for as at an initial selling price that, in one example embodiment, includes receiving bid purchases for the auction item. For each bid purchase received, an instant profit value based on the value of the bid purchase is determined, a seller account or one of a plurality of buyer accounts is credited with the instant profit value for the seller or corresponding buyer, and temporary holding right of the auction item to the seller or the buyer that provided the bid purchase is recorded. Successive bid purchases for the auction item are processed until the expiration of an auction time.

Also disclosed herein is an auction method that, in one example embodiment, includes selling an auction item from an initial seller to a first purchaser upon the first purchaser issuing a first bid purchase, and obligating the first purchaser to sell the auction item to a second purchaser upon the second purchaser issuing a second bid purchase, and so on.

### BRIEF DESCRIPTION OF THE DRAWINGS

The foregoing summary, as well as the following detailed description of preferred variations of the invention, will be better understood when read in conjunction with the appended drawings. For the purpose of illustrating the invention, there is shown in the drawings variations that are presently preferred. It should be understood, however, that the invention is not limited to the precise arrangements shown. In the drawings, where:

FIG. 1 is FIG. 1 is a block diagram of an example embodiment of an auction system.

FIG. 2 is a block diagram of another example embodiment of an auction system.

FIG. 3 is a flow diagram of an example auction process.

FIG. 4 is a flow diagram of another example auction process.

FIG. 5 is a flow diagram of an example process of determining an instant profit.

FIG. 6 is a flow diagram of another example process of determining an instant profit.

FIG. 7 is a flow diagram of an example auction hold process.

FIG. 8 is a flow diagram of another example auction process.

FIGS. 9-12 are block diagrams depicting participant obligations and elements of example auction instruments.

FIG. 13 is a flow diagram of another example auction process that includes a bid period timer.

FIG. 14 is a flow diagram of another example auction process that converts the last n-bids received into bid purchases.

FIG. 15 is a block diagram illustrating example physical components of an auction system which aspects of the present disclosure may be practiced.

### DETAILED DESCRIPTION

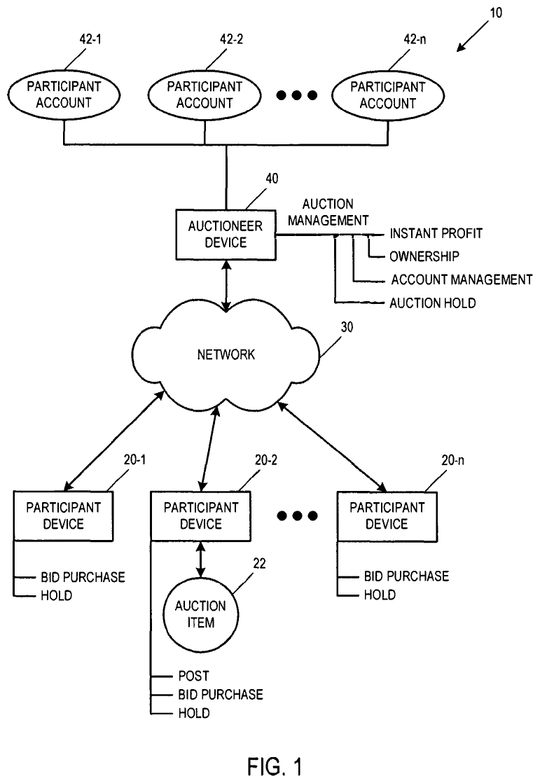

Implementations of the present technology FIG. 1 is a block diagram of an example embodiment of an auction system 10. The auction system 10 includes a plurality of participant devices 20-1, 20-2 . . . 20-n that are in data communication with an auctioneer device 40 via a network 30. The plurality of participant devices 20 correspond to a plurality of participants. Each participant device 20 is configured to receive auction information input by a corresponding participant and to display auction information to the participant. The auction information includes a post of an auction item 22 for sale by a participant at an initial selling price and bid purchases from the plurality of participants.

The auctioneer device 40 is configured to process the auction information received from the plurality of participant devices 20 and to manage an auction of the auction item 22. Auction management may include determining an instant profit, recording temporary holding right of the auction item, and perform account management, for example. The auctioneer device may be referred to as the auction system.

The participant devices 20 and the auctioneer device 40 may be realized by computing devices communicating over a wired or wireless network. For example, the participant devices 20 and auctioneer device 40 may comprise a plurality of client devices communicating with one or more servers over the Internet, or a plurality of wireless device communicating over one or more wireless networks, or a combination of wired and wireless communication devices communicating over a combination of wired and wireless networks. Such communication devices may include client and server computers, hand-held wireless devices, televisions, etc.

Many of the auction management functions are predicated on the characteristic of bid purchases received during an auction time and the resulting bid purchase transactions. In the auction system 10 of FIG. 1, a bid purchase results in the actual purchase of the auction item in which an temporary holding right interest is transferred from the owner of the auction item 22 to the participant that issued the bid purchase upon the bid purchase being received at the auctioneer device 40. Monetary consideration for the temporary holding right interest transfer is likewise debited from the current buyer's account and credited to the current seller's account upon the processing of the bid purchase at the auctioneer device 40.

For example, if a first participant using the participant device 20-2 posts the auction item 22 for sale at an initial selling price P₀, and thereafter a second participant using the participant device 20-1 issues a bid purchase P₁ in excess of the initial selling price P₀, then an temporary holding right interest in the auction item 22 is transferred from the first participant to the second participant, and the corresponding first participant account and second participant account are credited and debited accordingly. The second participant is thereafter obligated to sell the auction item 22 to the next participant that issues a bid purchase P₂ that is in excess of P₁ during the auction time, and likewise subsequent purchasers are obligated to sell the auction item to further subsequent purchasers upon the further subsequent purchasers issuing further subsequent bid purchases Pᵢ until the expiration of an auction time. With each bid purchase sale, corresponding participant accounts are credited and debited accordingly.

The auctioneer device 40 is configured to determine an instant profit value upon receiving a bid purchase from a participant. The instant profit value is based on the value of the bid purchase. With each bid purchase, the auctioneer device 40 manages participant accounts 42-1, 42-2 . . . 42-n that correspond to the auction participants. The auctioneer device 40 credits participant accounts 42 with instant profit values for the participants, records temporary holding right of the auction item 22 to the participant that provides a bid purchase, and processes successive bid purchases for the auction item 22 until the expiration of an auction time. Which accounts 42 are credited depends on the type of instant profit value determined.

In one embodiment, the instant profit value is based on the difference of the bid purchase Pᵢ and a previous bid purchase Pᵢ₋₁ issued by another participant, i.e., Pᵢ-Pᵢ₋₁, and is credited to a participant account 42 associated with the participant that issued the bid purchase Pᵢ. In another embodiment, the instant profit value is based on the difference of the bid purchase Pᵢ and a subsequent bid purchase Pᵢ₊₁ issued by another participant, i.e., Pᵢ₊₁-Pᵢ, and is credited to the account of the participant that issued the bid purchase Pᵢ.

In yet another embodiment, the instant profit for a bid purchase issued by a participant may be further determined by multiplying the difference based on the bid purchase by an instant profit scalar aᵢ, e.g., (Pᵢ-Pᵢ₋₁)*aᵢ. The remainder of the price differential, e.g., (Pᵢ-Pᵢ₋₁)(1-aᵢ), may be credited to the participant account associate with the initial seller of the auction item 22, or may be apportioned between that participant account associate with the initial seller of the auction item 22 and an auction house account.

In one embodiment, the value of aᵢ for each instant profit calculation may be the same, e.g., a value between 0 and 1. In another embodiment, the value of aᵢ may vary for each instant profit calculation or each bid purchase. For example, in one embodiment, aᵢ increases with each subsequent purchase until obtaining a maximum value to provide incentive for later purchases. In another embodiment, aᵢ may be scaled based on the value of the current purchase price compared to the previous purchase price to provide incentive for larger bid purchases. In yet another embodiment, aᵢ may vary based on a purchaser's purchase history within the current auction. In yet another embodiment, aᵢ may vary based on a purchaser's purchase history with the auction service.

Table 1, below, illustrates how the value of aᵢ may vary linearly with each subsequent purchase. For each purchase, the value of aᵢ increases by 1% and maximizes at 6%. The initial value of aᵢ, i.e., aᵢ, is 2%. P₀ corresponds to an initial price set by the initial seller and Pᵢ-Pₛ correspond to purchase prices. The buyers instant profit is calculated by the formula (Pᵢ-Pᵢ₋₁)*aᵢ. The auction house share is 1% of the sale price for P₁, and 1% of each subsequent differential share price (Pᵢ=Pᵢ₋₁). The payment to the seller is P₁ minus the buyer's instant profit and minus the auction house share for the first sale at P₁, and (Pᵢ-Pᵢ₋₁) minus the buyer's instant profit and minus the auction house share for each subsequent sale i, where i>1.

| | | | Buyer's | Auction | Payment To |
|---|---|---|---|---|---|
| i | Pᵢ | aᵢ | Instant Profit | House Share | Initial Seller |
| 0 | 10000 | N/A | N/A | N/A | N/A |
| 1 | 11000 | 0.02 | 20 | 110 | 10870 |
| 2 | 12000 | 0.03 | 30 | 10 | 960 |
| 3 | 14000 | 0.04 | 80 | 20 | 1900 |
| 4 | 15000 | 0.05 | 50 | 10 | 940 |
| 5 | 17000 | 0.06 | 120 | 20 | 1860 |

Table 2 below illustrates how the value of aᵢ may vary based on a current purchase price compared to a previous purchase price. For each purchase, the value of aᵢ is equal to one-half of the percentage increase of the current purchase price from the previous purchase price, up to a maximum of 5%. P₀ corresponds to an initial price set by the initial seller and P₁-P₅ correspond to purchase prices. The instant profit for a previous buyer i is calculated by the formula (Pᵢ₊₁-Pᵢ)*aᵢ. The auction house share is 1% of the sale price for P₁, and 1% of each subsequent differential share price (Pᵢ-Pᵢ₋₁). The payment to the seller is P₁ minus the auction house share for the first sale at P₁, and (Pᵢ-Pᵢ₋₁) minus the buyer's instant profit and minus the auction house share for each subsequent sale Pᵢ, where i>1.

| | | | Previous Buyer's | Auction | Payment To |
|---|---|---|---|---|---|
| i | Pᵢ | aᵢ | Instant Profit | House Share | Initial Seller |
| 0 | 10000 | N/A | N/A | N/A | N/A |
| 1 | 11000 | 0.05 | N/A | 110 | 10890 |
| 2 | 12000 | 0.0455 | 50 | 10 | 940 |
| 3 | 14000 | 0.05 | 90.91 | 20 | 1889.09 |
| 4 | 15000 | 0.0357 | 50 | 10 | 940 |
| 5 | 17000 | 0.05 | 71.43 | 20 | 1908.57 |

Note that in both Tables 1 and 2, all participants receive some consideration for participating in the auction. In the auction system illustrated by the results of Table 1, each participant i that issues a bid purchase receives an instant profit of (Pᵢ-Pᵢ₋₁)*aᵢ upon the processing of the bid purchase Pᵢ, where i=1 . . . 5. Thus, regardless of whether a participant i obtains final ownership of the auction item 22, the participant i receives consideration proportional to the magnitude of the participant's bid purchase Pᵢ relative to a previous bid purchase Pᵢ₋₁.

Likewise, in the auction system illustrated by the results of Table 2, each participant i that issues a bid purchase receives an instant profit of (Pᵢ₊₁-Pᵢ)*aᵢ upon another participant issuing a subsequent bid purchase Pᵢ₊₁. Thus, if a participant i does not obtain final ownership of the auction item 22, the participant i receives consideration proportional to the magnitude of a subsequent bid purchase Pᵢ₊₁ relative to the participant's bid purchase Pᵢ.

An initial seller may participate in the auction after the initial sale of the item 22. Thus, should the initial seller reconsider selling the auction item, the initial seller may participate in the auction in an attempt to repurchase the auction item.

In one embodiment, the initial seller may also be configured to issue an optional hold command with a bid purchase to suspend the auction, and thereafter may issue additional hold commands to either terminate the auction or resume the auction. Should the seller decide to terminate the auction within a predefined hold time period, then the auction is terminated and final ownership rests with the last bidder.

The auctioneer device 40 correspondingly processes auction hold commands and conditions by suspending processing of subsequent bid purchases for the hold time period upon receiving an auction hold command, terminating the auction upon receiving a terminate auction hold command, and resumes processing of subsequent bid purchases upon receiving a resume auction hold command or upon expiration of the hold time period. In one embodiment, the auctioneer device 40 is configured to suspend processing of subsequent bid purchases by precluding issuance of subsequent bid purchases from the participants during the hold time period. In another embodiment, the auctioneer device 40 is configured to suspend processing of subsequent bid purchases by queuing subsequent bid purchases by the participants during the hold time period. The queued bid purchases are batch processed if the auction resumes, or are discarded if the auction is terminated.

In a different embodiment, the auction system 10 is be configured to receive bids for the auction item during an auction time, and convert a penultimate bid received from a penultimate bidder and a final bid received from a final bidder to a penultimate bid purchase and a final bid purchase, respectively. The auctioneer device 40 determines an instant profit value based on the value of the penultimate bid purchase, and credits a corresponding penultimate bidder account with the instant profit value. The title of the auction item is then transferred from an initial seller to the penultimate bidder. Thereafter, the title may then be transferred from the penultimate bidder to the final bidder.

This embodiment may be expanded to convert n-previous bids received from n-previous bidders to n-bid purchases. For each n-bid purchases received from the n-previous bidders, the auctioneer device 40 determines an instant profit value based on the value of the n^{th} bid purchase, credits a corresponding n^{th} bidder account with the instant profit value, and records temporary holding right of the auction item to the n^{th} bidder from the previous bidder or initial seller.

The value of n may be fixed, e.g., 1 or greater. In another embodiment, the value of n is proportional to the number of bids received and determined at the end of the auction. For example, if n is based on 20% of the bids received, and 100 bids are received, then the last 20 bids shall be converted to bid purchases. Other methods of determining the value of n may also be used.

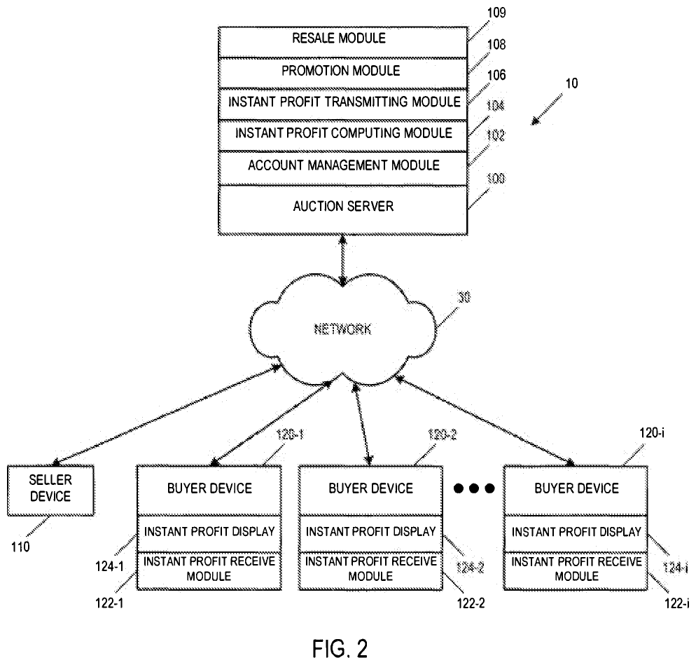

FIG. 2 is a block diagram of another example embodiment of an auction system 10 implemented in a computer network. In FIG. 2, an electronic auction system 10 comprises at least one seller device 110, e.g., an initial seller using a personal computer connected to the Internet 30, a plurality of buyer devices 120-1, 120-2 . . . 120-i, e.g., a plurality of buyers using personal computers connected to the Internet 30, and at least one auction server 100, e.g., a computer server connected to the Internet 30. The seller device 110 and the buyer devices 120-1, 120-2 . . . 120-i communicate with the auction server 100 via the network 30.

The auction server 100 further comprises a buyer account management module 102, an instant profit computing module 104, an instant profit transmitting module 106, a promotion module 108, and a resale module 109. The modules may be realized by software stored in a computer-readable medium.

The buyer account management module 102 manages balances for each buyer's account during each buying and selling cycle. In one embodiment, each buyer is required to deposit a predetermined amount of currency in order to be qualified to participate in an auction to make a bid purchase. The deposit may be facilitated by any payment method.

Each of the buyer devices 120-1, 120-2 . . . 120-i further comprises an instant profit receive module 122-1, 122-2 . . . 122-i, and also comprises an instant profit display 124-1, 124-2 . . . 124-i. Auction information may thereby be received, transmitted and displayed on each of the buyer devices 120-1, 120-2 . . . 120-i.

A seller uses the seller device 110 to begin an auction of an item by posting auction information to the auction server 100. The auction information may include a selling price P₀ and a bid increment ΔP set by the seller and which is stored at the action server 100 upon receipt.

The first buyer then issues a first bid purchase of the auction item and sets a buying price P₁ by using the first buyer device 120-1. The auction server 100 deducts the first buyer's account and credits to the seller's account a value based on the buying price P₁, and at the same time, the temporary holding right of the item is recorded with the first buyer's account via the buyer account management module 102.

The instant profit computing module 104 also computes an instant profit for the first buyer. One example instant profit formula is (Pᵢ-P₀)*a₁, where a₁ is an instant profit scalar between 0 and 1. The instant profit (P₁-P₀)*a₁ is earned by the first buyer regardless of whether the first buyer retains final ownership of the auction item.

The instant profit transmitting module 106 transmits instant profit information from the auction server 100 to the first buyer device 120-1. The instant profit information is received by the instant profit receive module 122-1 of the first buyer device 120-1 and displayed by the instant profit display 124-1.

Subsequently, the second buyer may issue a second bid purchase P₂ for the auction item if an auction time limit has not been reached. The auction server 100 deducts the second buyer's account and credits the first buyer's account a value based on the buying price P₂, and at the same time, the temporary holding right of the item is recorded with the second buyer's account via the buyer account management module 102.

The instant profit computing module 104 also computes an instant profit for the second buyer according to the instant profit formula (P₂-P₁)*a₂, where a₂ is an instant profit scalar between 0 and 1. The instant profit (P₂-Pᵢ)*a₂ is earned by second buyer regardless of whether the second buyer retains final ownership.

The instant profit transmitting module 106 transmits instant profit information from the auction server 100 to the second buyer device 120-2, where the instant profit information is received and displayed. The seller also receives payment based on a portion of the price difference between the first and second buyers, i.e., a portion of P₂-P₁.

In some embodiments, the promotion module 108 computes an incentive value for the buyer according to one of 1) the available promotional funds accumulated by the auction system or 2) the promotional funds that became available as a result of an increased auction house share of a final sale price of the auction item. The promotion module 108 transmits the incentive value information from the auction system to the buyer devices, where the incentive value information is received and displayed. The buyer receives payment based on the incentive value. The incentive value can be scaled on factors such as, but not limited to, the number of bids, the time elapsed since the last bid was received, the time remaining before auction expiration, and the current bid value compared to a minimum final sale price.

In some embodiments, the resale module 109 detects auction items relisted for sale on the auction system after an initial sale of the auction item has already occurred. Detection may occur through the use of image recognition programs to detect the use of images accompanying previously held auctions, natural language text parsing programs to detect the use of similar descriptive information accompanying previously held auctions, and the like. The resale module 109 computes a creator fee. The resale module 109 transmits the creator fee from the auction system to the creator device, where the creator fee information is received and displayed. The creator receives payment based on the creator fee. The creator fee may be set and scaled according to any of the fee formulas disclosed in this paper.

Table 3 below illustrates how the creator fee can be calculated. P₀ is the final sale price of the auction item in an auction on the auction system. Here, the creator fee is larger for the first sale at P₁ and is smaller for subsequent sales P₂-P₅.

| | | | Buyer's | Auction | Payment To | Payment to |
|---|---|---|---|---|---|---|
| | | | Instant | House | Current | Original |
| i | Pᵢ | aᵢ | Profit | Share | Seller | Seller |
| 0 | 10000 | N/A | N/A | N/A | N/A | N/A |
| 1 | 11000 | 0.02 | 20 | 110 | 10,326.50 | 543.50 |
| 2 | 12000 | 0.03 | 30 | 10 | 912 | 48 |
| 3 | 14000 | 0.04 | 80 | 20 | 1805 | 95 |
| 4 | 15000 | 0.05 | 50 | 10 | 893 | 47 |
| 5 | 17000 | 0.06 | 120 | 20 | 1767 | 93 |

It should be recognized that the original seller may not be the original creator. In such scenarios, the auction system will make attempts to locate and reimburse the original creator. The auction system may set aside a percentage of each subsequent bid purchase as a royalty fee into a separate escrow account. Royalty fees from this escrow account may be claimed at a later date by the original creator or his/her estate.

The auction process continues until the expiration of an auction time. In one embodiment, the auction time expires after a predefined time period. In another embodiment, the auction time expires if a bid purchase is not received within a predefined time period. At any moment, a buyer i may issue a bid purchase i if the auction time has not expired and the bid purchase is processed as described above.

In some embodiments, the auctioneer device 40 or the buyer account management module 102 may transmit auction related data (e.g., ownership of the auction item or the identity, sale price, and transaction date of the bid purchase) to a location associated with a distributed ledger system 101 (also referred to herein as a blockchain network) to be recorded. Exemplary distributed ledger systems may include, but are not limited to, ETHEREUM, BITCOIN, HYPER LEDGER and many others.

In one embodiment, the auctioneer device 40 or the buyer account management module 102 may record the auction related data by transmitting such information via a transaction to a smart contract 103 (“smart contract transaction”) located on the blockchain network 101. The smart contract 103 may follow the Contract Application Binary Interface (“ABI”) for ETHEREUM, or other contract specifications if other blockchain networks are employed.

The smart contract 103 is associated with location information. In one embodiment, location information comprises a smart contract address deterministically computed from the address of its creator (e.g., the auctioneer device 40 or the buyer account management module 102) and the number of transactions sent by the creator (i.e., nonce). This allows the buyer account management module 102 to incorporate the address into the digital certificate information of a digital certificate, to generate authenticity information, and to record the authenticity information via transaction the smart contract 103. In an optional step (not shown) a transaction ID may be generated by the blockchain network 101 and stored as proof of the creation of the smart contract 103 by the auctioneer device 40 or the buyer account management module 102.

In one embodiment, the location information may include an address to locate a non-smart contract transaction in a particular block of the blockchain. In yet another embodiment, the authenticity information may be stored in a database (i.e., through a database management system of the user device, a local server, a cloud storage system, or a distributed file storage system).

Generally, the decentralized architecture provided by blockchain technology, combined with the use of smart contracts, provides the best solution for managing transactions using a decentralized common database which does not involve third parties. Additionally, vast networks of independent nodes, complex cryptographic communication, and group consensus on ledger updates prevent the possibility of falsifying data on transactions that are public by nature and completely open to users-making data immutable and reliable throughout the network. It will be appreciated that falsification or deletion of blockchain information is prevented, in part, through the implementation of consensus algorithms which oblige independent nodes to agree on past transactions before proceeding to incorporate the transactions in the next proposed block.

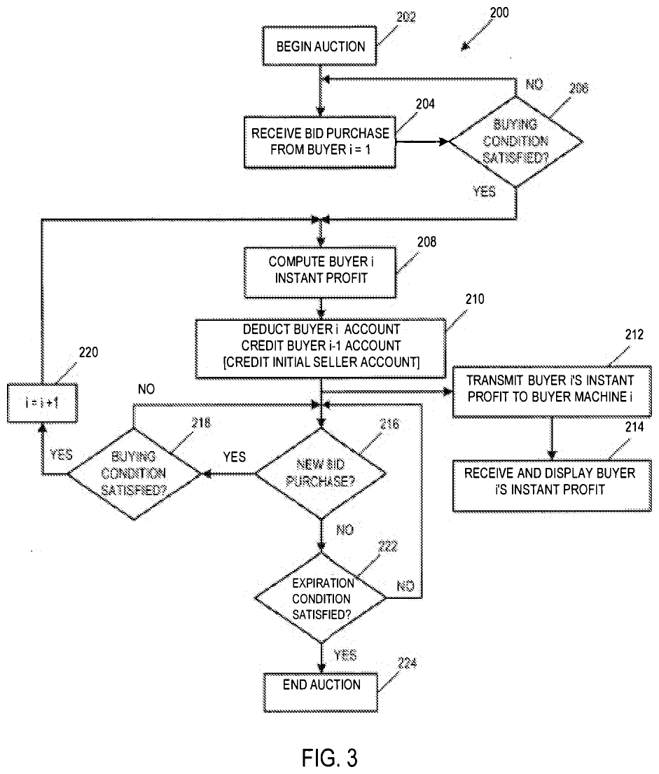

FIG. 3 is a flow diagram 200 of an example auction process 200. At step 202 a seller begins the auction by posting auction information regarding an auction item. The auction information may include a selling price P₀ and a purchase increment ΔP set by the seller.

At step 204, a bid purchase from a first buyer is received for the item, and a counter i is set to 1. Step 206 determines if the bid purchase satisfies a buying condition. A buying condition may be satisfied if the bid purchase exceeds a purchase increment ΔP over the existing price, i.e., either P₀ or the price of the last satisfactory bid purchase. If the buying condition is not satisfied, the process returns to step 204.

If the buying condition is satisfied, then step 208 determines the first buyer's instant profit and the seller's credit. If the first buyer will not receive an instant profit until a subsequent sale of the auction item, then step 208 will return a value of 0 for the first buyer. At step 210, the buyer's account is debited and the seller's account is credited, and ownership is recorded to the buyer. The debit to the buyer's account and the credit to the seller's account may also reflect the instant profit attributed to the buyer. If so, step 212 transmits the instant profit value to the buyer i's device, and step 214 displays the instant profit value.

After step 210, step 216 determines if a new bid purchase is received. If so, step 218 determines if the bid purchase satisfies a buying condition. If the buying condition is not satisfied, the process returns to step 216. If the buying condition is satisfied, then step 220 increments the counter by 1, and the process returns to step 208. At the second and subsequent execution of step 210, the initial seller's account may also be credited with residual consideration for each subsequent purchase.

If step 216 determines that a bid purchase has not been received, then step 222 determines if an auction expiration condition has been satisfied. In one embodiment, the auction expiration condition is a predefined time period for the auction, e.g., 48 hours, and the action expiration condition is satisfied once the predefined time period has been reached. Alternatively, there is no predefined time period for the auction. In another embodiment, the auction expiration condition is a predefined time period, e.g., 1 hour, 1 week, 1 month, for successive bid purchases and the auction expiration condition is satisfied after no new bid purchase is received within the predefined time period. In yet another embodiment, the auction expiration condition is a minimum final sale price, e.g., $1000 to preclude successive bids and to retain final ownership of the auction item, and the auction expiration condition is satisfied once a bid at or above the minimum final sale price is received. If the auction expiration condition has not been satisfied, then the process returns to step 216; otherwise, step 224 ends the auction.

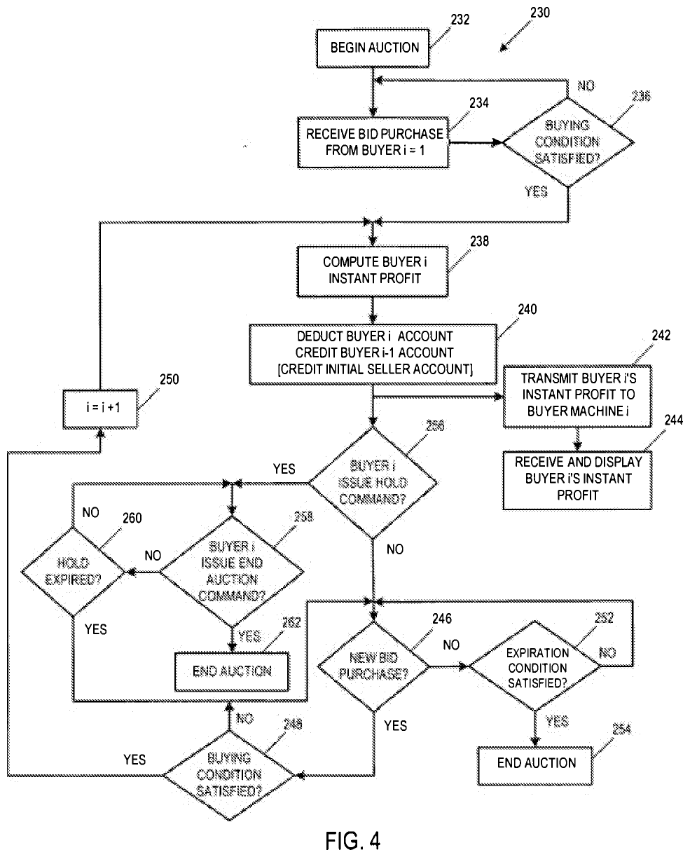

FIG. 4 is a flow diagram 230 of another example auction process 230. In this embodiment, a buyer may issue one or more hold commands with a bid purchase. Steps 232, 234, 236, 238, 240, 242, 244, 246, 248, 250, 252, and 254 perform the same process as described with respect to step 202, 204, 206, 208, 210, 212, 214, 216, 218, 220, 222, and 224 of the flow diagram 200 of FIG. 2. However, after the execution of step 240 of FIG. 4, step 256 determines if the current buyer issued a hold command. If a hold command was not issued, then the process proceeds to step 246,

If, however, the current buyer did issue a hold command, then step 258 determines if the buyer has issued an end auction command. An end auction command may include a command that indicates that the current buyer wants to retain final ownership of the auction item, and may be issued as the initial hold command or may be subsequently issued during a hold time period. In some embodiments, one of the auction expirations conditions is receiving the end auction command.

If the current buyer has not issued an end auction command, then step 260 determines if a hold time has expired. The hold time may expire upon the expiration of a time period, e.g., 15 minutes, or may expire upon receiving a resume auction command from the current buyer. If the hold time has not expired, then the process returns to step 258. If the hold time has expired, then the process returns to step 246.

In one embodiment, processing of subsequent bid purchases is suspended by precluding issuance of subsequent bid purchases from buyers during the hold time period. In another embodiment, processing of subsequent bid purchases is suspended by queuing subsequent bid purchases by the participants during the hold time period. The queued bid purchases are batch processed if the auction resumes, or are discarded if the auction is terminated.

If the current buyer decides to terminate the auction, then step 262 ends the auction.

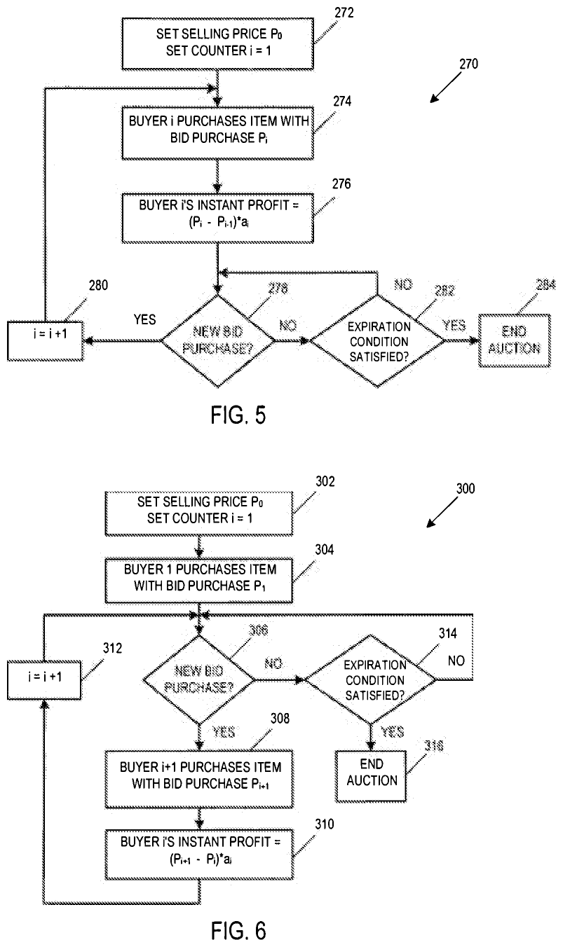

FIG. 5 is a flow diagram 270 of an example process of determining an instant profit. In this example process, a buyer i receives an instant profit based on the difference of the buyer i's bid purchase Pᵢ and a previous bid purchase Pᵢ₋₁. At step 272, an initial seller sets the selling price P₀, and the counter i is set to 1. At step 274, a buyer i purchases the auction item with a bid purchase Pᵢ. Thereafter, step 276 determines the buyer i's instant profit according to the formula (Pᵢ-Pᵢ₋₁)*aᵢ. Step 278 determines if a new bid purchase has been received. If so, step 280 increments the counter by 1 and the process returns to step 274.

If a new bid purchase has not been received, step 282 determines if an auction expiration condition has been satisfied. If an auction expiration condition has not been satisfied, the process returns to step 278; otherwise, step 284 ends the auction. 314

FIG. 6 is a flow diagram 300 of another example process of determining instant profit. In this example process, a buyer i receives an instant profit based on the difference of the buyer i's bid purchase P₁ and a subsequent bid purchase Pᵢ₊₁. At step 302, an initial seller sets the selling price P₀, and the counter i is set to 1. At step 304, a first buyer purchases the auction item with a bid purchase P₁. Step 306 determines if a new bid purchase has been received. If so, then buyer i+1 purchases the auction item with a bid purchase Pᵢ₊₁ in step 308. Step 310 thereafter determines buyer i's instant profit according to the formula (Pᵢ₊₁-Pᵢ)*aᵢ. Step 312 then increments the counter i by 1 and the process returns to step 306.

If step 306 determines that a bid purchase has not been received, then step 314 determines if an auction expiration condition has been satisfied. If an auction expiration condition has not been satisfied, the process returns to step 306; otherwise, step 316 ends the auction.

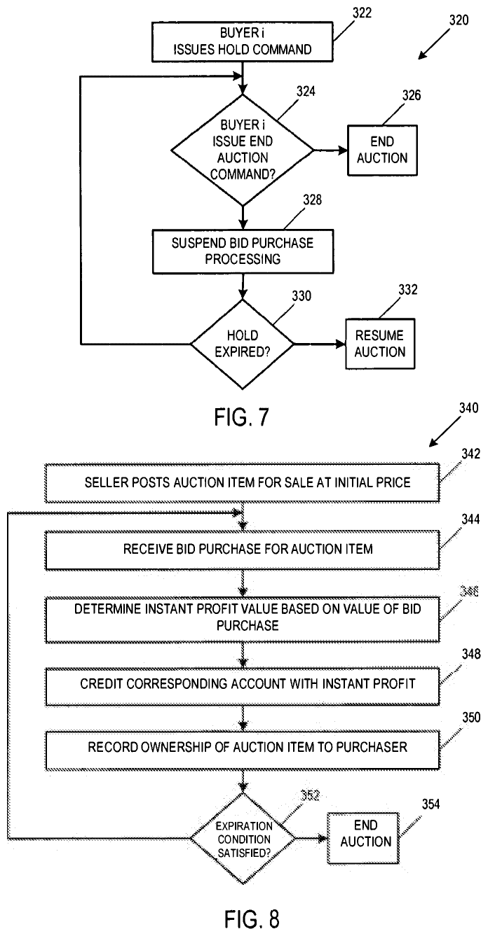

FIG. 7 is a flow diagram 320 of an example auction hold process. In step 322, a buyer i issues an auction hold command. Step 324 determines if the buyer i has issued an end auction command. An end auction command may include a command that indicates that the buyer wants to retain final ownership of the auction item, and may be issued as the initial hold command or may be subsequently issued during a hold time period. In some embodiments, one of the auction expirations conditions is receiving the end auction command.

If the current buyer has not issued an end auction command, then step 328 suspends bid purchase processing. Processing of bid purchases is suspended by precluding issuance of subsequent bid purchases from buyers during the hold time period or by queuing subsequent bid purchases by the participants during the hold time period. The queued bid purchases are batch processed if the auction resumes, or are discarded if the auction is terminated.

Step 330 determines if the hold condition has expired. The hold condition may expire upon the expiration of an auction hold time, upon the buyer issuing a hold command that indicates that the buyer wants to retain final ownership of the auction item, or upon the buyer issuing a hold command that indicates the buyer wants the auction to resume. If the hold condition has not expired, the process returns to step 324; otherwise, the action resumes in step 332.

FIG. 8 is a flow diagram 340 of another example auction process. In step 342, an initial seller posts an auction item for sale at an initial selling price. In step 344, a bid purchase for the auction item is received. Step 346 determines the instant profit value based on the value of the bid purchase, and step 348 credits a corresponding account with the instant profit. Step 350 records the ownership of the auction item to the purchaser. Step 352 determines if an auction expiration condition has been satisfied. If an auction expiration condition has not been satisfied, then the process returns to step 344; otherwise, step 354 ends the auction.

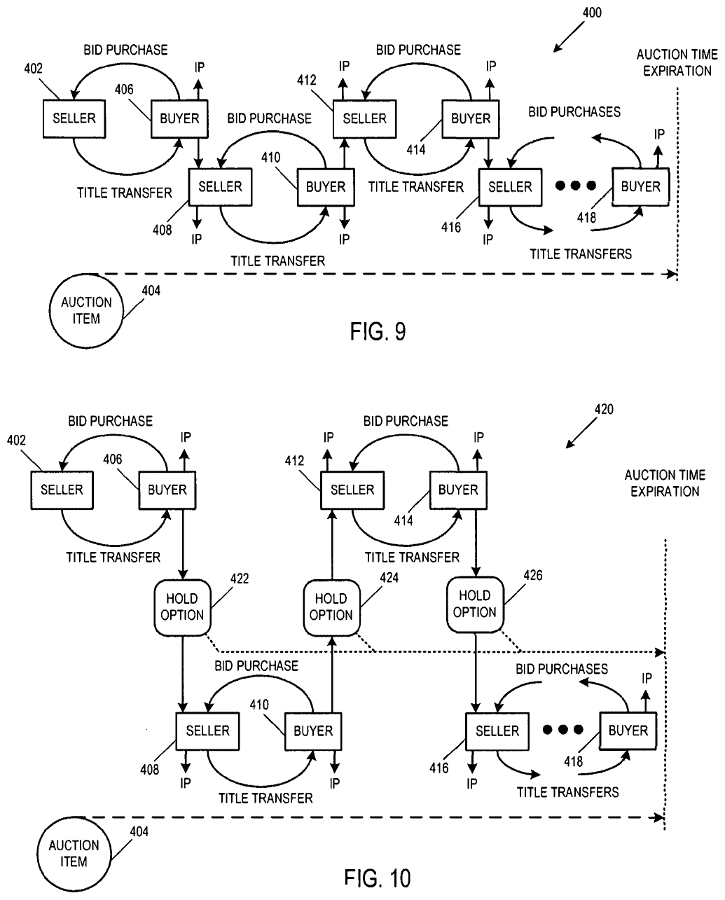

FIGS. 9-12 are block diagrams depicting participant obligations and elements of example auction instruments. The example auction instruments may be realized by a contract, a click wrap agreement, a smart contract, and the like. Performance of the obligations may be done directly by sellers and purchasers, facilitated through a third party, or performed by proxies of the sellers and purchasers.

The auction instrument 400 of FIG. 9 imposes an initial seller 402 obligation to sell an auction item 404 to a first buyer 406 upon the first buyer 406 issuing a bid purchase. As a result of the bid purchase, the title to the auction item 404 transfers to the buyer 406, and the initial seller 402 receives consideration based on the amount of the bid purchase. Thereafter, the buyer 406 assumes the role of a seller 408 and is obligated to sell the auction item 404 to a second buyer 410 upon the second buyer 410 issuing a bid purchase. As a result of the second bid purchase, the title to the auction item 404 transfers to the buyer 410, and the buyer 406/seller 408 receives consideration based on the amount of the bid purchase. Subsequent buyer 414/seller 416 obligations to sell the auction item 404 to further subsequent buyers upon the further subsequent purchasers issuing further subsequent bid purchases continues until the expiry of an auction time, at which time title to the auction item 404 is retained by a final buyer 418.

With each purchase, a buyer may receive an instant profit based on the difference of the buyer's bid purchase value Pᵢ and a previous bid purchase Pᵢ₋₁, or initial selling price P₀, and as indicated by the IP arrows extending from each buyer element 406, 410, 414, and 418. In another embodiment, the instant profit value is based on the difference of the bid purchase Pᵢ and a subsequent bid purchase Pᵢ₊₁ subsequently issued by another buyer, as indicated from the IP arrows extending from the seller elements 408, 412 and 416.

The auction instrument 420 of FIG. 10 imposes similar conditions and obligations as described with respect to FIG. 9, and also provides for buyers 406, 410, and 414 to exercise hold options 422, 424 and 426 to hold the auction item 404 for a hold time period. During the hold time period, the buyers may decide to terminate the auction to retain final title to the auction item, or may terminate the hold options to resume the auction. The hold options may be terminated expressly by the buyers or upon the expiration of a hold time period. As depicted in FIG. 10, the obligation of a buyer to sell the auction item 404 to further subsequent buyers attaches only if the buyer does not exercise the hold option or the hold option is terminated to resume the auction.

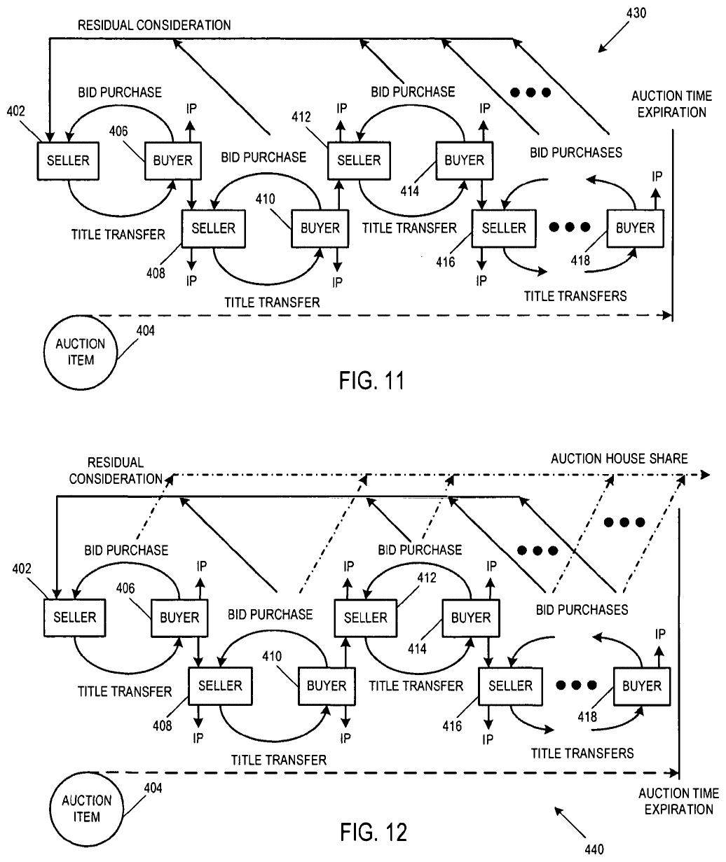

The auction instrument 430 of FIG. 11 imposes similar conditions and obligations as described with respect to FIG. 9, and also requires residual consideration for one or more bid purchases to be provided to the initial seller. Because the instant profit for each transaction may be less than the total appreciation in price, i.e., the instant profit may be based in part on the instant profit scalar aᵢ, the residual of the price differential between successive bid purchases may be credited to the initial seller. Table 4 below provides examples of instant profit and residual consideration calculations and the bid purchases to which the calculations apply.

| Instant Profit | Residual Consideration | Bid Purchases |
|---|---|---|
| (Pᵢ − Pᵢ₋₁)*aᵢ | (Pᵢ − Pᵢ₋₁)*(1 − aᵢ) | i = 1 . . . n |
| (Pᵢ₊₁ − Pᵢ)*aᵢ | (Pᵢ₊₁ − Pᵢ)*(1 − aᵢ) | i = 1 . . . n − 1 |

The auction instrument 440 of FIG. 12 imposes similar conditions and obligations as described with respect to FIG. 10, and also requires a share of one or more bid purchases to be provided to an auction house. The auction house may be an entity that conducts the auction. The share may be a fixed percentage b, or may be a variable percentage bi that varies with each transaction in a manner similar to the instant profit scalar. The auction house shares may be subtracted from the residual consideration values of Table 4 above for each bid purchase.

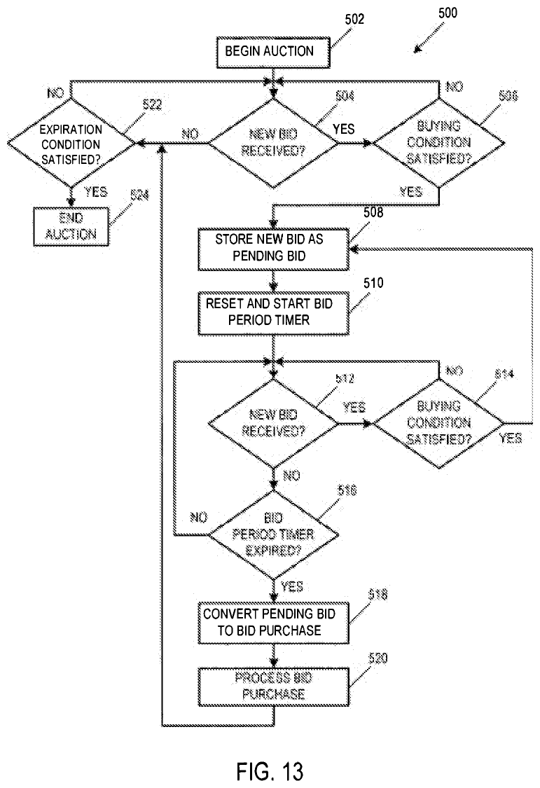

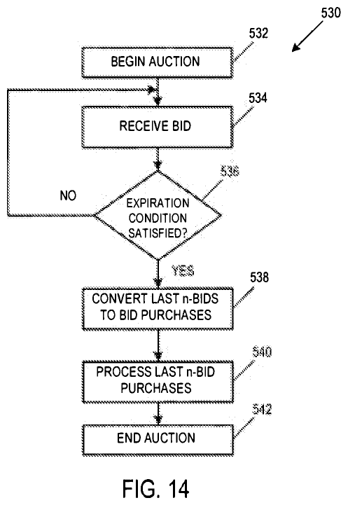

The auction system and method described herein may also be applied to existing auctions in a hybrid style. FIGS. 13 and 14 are flow diagrams that illustrate example hybrid systems.

FIG. 13 is a flow diagram 500 of another example auction process that includes a bid period timer. In this embodiment, a bid period timer is reset upon receiving a bid that satisfies a buying condition. Ownership and consideration (e.g., the crediting and debiting of participant accounts) does not transfer for the pending bid until expiration of the bid period timer. During the countdown of the bid period timer, however, if another bid is received that satisfies a buying condition based on the pending bid, then the bid period timer is reset and the new bid becomes the pending bid. If the bid period timer expires, then the pending bid is converted to a bid purchase and processed accordingly, i.e., instant profit, debit and credit processes are performed and a change in ownership is recorded.

The auction begins in step 502, and step 504 determines if a new bid is received. If a new bid is received, then step 506 determines if a buying condition is satisfied. If a buying condition is not satisfied, then the process returns to step 504. If a buying condition is satisfied, however, then step 508 stores the new bid as a pending bid.

Step 510 then resets and starts a bid period timer. The bid period time may be a clock that counts down a bid period, e.g., 30 minutes. The bid period timer may also automatically expire if the auction time expires.

Step 512 determines if a new bid is received during the bid period. If a new bid is received, then step 514 determines if a buying condition is satisfied based on the pending bid. For example, if a minimum bid increment is $10, then the new bid received must exceed the pending bid by $10. If a buying condition is not satisfied, then the process returns to step 512. If a buying condition is satisfied, however, then the process returns to step 508, and the new bid is stored as the pending bid.

If step 512 determines that a new bid is not received, then step 516 determines if the bid period timer has expired. If the bid period timer has not expired, then the process returns to step 512. Conversely, if the bid period timer has expired, then step 518 converts the pending bid to a bid purchase, and step 520 processes the bid purchase, e.g., instant profit, debit and credit processes are performed and a change in ownership is recorded.

Upon the completion of step 520, or upon step 504 determining that a new bid has not been received, step 522 determines if an auction expiration condition has been satisfied. If an auction expiration condition has not been satisfied, then the process returns to step 504; otherwise, step 524 ends the auction.

In a variation of this embodiment, a hold process is initiated upon converting the pending bid to a bid purchase. The participant that issued the bid that is converted to the bid purchase may then decide to either terminate the auction or resume the auction as described above.

FIG. 14 is a flow diagram 530 of another example auction process that converts the last n-bids received into bid purchases. Bid purchase processing for the last n-purchaser is then performed. For example, an instant profit may be provided to a penultimate purchaser in an auction, or may be provided to the last n purchasers in an auction.

Step 532 begins the auction, and a bid is received in step 534. Step 536 determines if an auction expiration condition has been satisfied. If an auction expiration condition has not been satisfied, then step 534 receives additional bids. If an auction time has expired, however, then step 538 converts the last n-bids to bid purchases. The number n may be a fixed number, e.g., 1 or greater, or may be a variable number, such as a number determined by a percentage of the total number of bids received. Step 540 then processes the last n-bid purchases, and step 542 ends the auction.

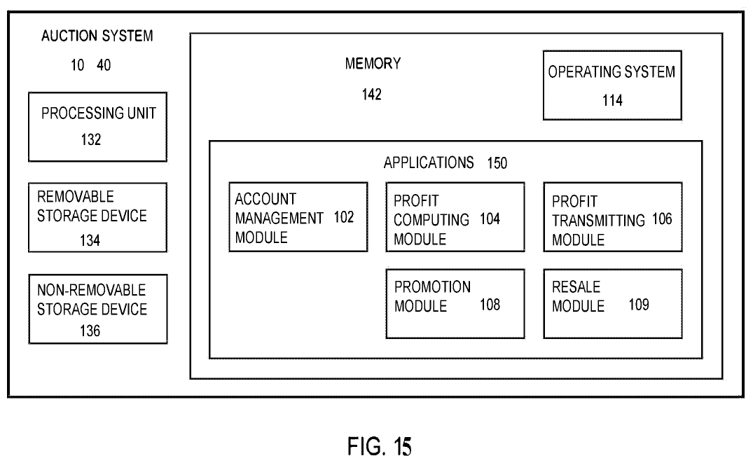

FIG. 15 is a block diagram illustrating example physical components (e.g. hardware) of the auctioneer device 40 or the auction system 10. The basic configuration is illustrated by those components within the dashed line. In this basic configuration, the auctioneer device 40 or the auction system 10 may include at least one processing unit 132 and memory 142.

The processing unit 132 executes commands to perform the functions specified in flowcharts and/or block diagram blocks throughout this disclosure. It should be appreciated that processing may be implemented either locally via the processing unit 132 or remotely via various forms of wireless or wired networking technologies or a combination of both.

The term computer readable media as used herein may include computer storage media. Computer storage media may include volatile and nonvolatile, removable and non-removable media implemented in any method or technology for storage of information, such as computer readable instructions, data structures, or program modules. The memory 142, the removable storage device 134, and the non-removable storage device 136 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the auctioneer device 40 or the buyer account management module 102. In some embodiments, such computer storage media may be part of the auctioneer device 40 or the buyer account management module 102. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Memory 142 may include various types of short and long-term memory as is known in the art. Memory 142 may be loaded with various applications 150 in the form of as computer readable program instructions. These computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Applications 150 may include the aforementioned account management module 102, instant profit computing module 104, instant profit transmitting module 106, promotion module 108, and resale module 109. Accordingly, memory 112 includes all necessary applications per each embodiment. In some embodiments, applications 150 include image recognition and text parsing programs.

Memory 112 may also include an operating system 114 suitable for controlling the operation of the auctioneer device 40 or the auction system 10.

The steps and the order of the steps in the methods and flowcharts described herein may be altered, modified and/or augmented and still achieve the desired outcome. Additionally, the methods, flow diagrams and structure block diagrams described herein may be implemented in the example processing devices described herein by program code comprising program instructions that are executable by the device processing subsystem. Other implementations may also be used, however, such as firmware or even appropriately designed hardware configured to carry out the methods and flow diagrams or implement the structure block diagrams described herein. Additionally, the methods, flow diagrams and structure block diagrams that describe particular methods and/or corresponding acts in support of steps and corresponding functions in support of disclosed software structures may also be implemented in software stored in a computer readable medium and equivalents thereof. The software structures may comprise source code, object code, machine code, or any other persistently or temporarily stored code that is operable to cause one or more processing systems to perform the methods described herein or realize the structures described herein.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

1. An auction system to operate in conjunction with a seller device configured to receive auction information input by a seller and to display auction information to the seller and a plurality of buyer devices configured to display the auction information to a plurality of buyers and to receive further auction information input by the plurality of buyers, the auction system comprising:
memory storing executable instructions;
a processing device executing the instructions, wherein the instructions cause the processing device to:
determine instant profit values upon receiving a bid purchase from a buyer or upon the satisfaction of an auction expiration condition, the instant profit value based on the value of the bid purchase;
transmit the instant profit value to the buyer devices;
manage a seller account and buyer accounts;
credit the seller account or one of the buyer accounts with the instant profit value;
record ownership of the auction item to the buyer that provided the bid purchase upon receiving a bid purchase from a buyer;
process successive bid purchases for the auction item until the auction expiration condition is satisfied; and
detect a relisting of the auction item in a new auction on the auction system:
wherein
the detection of the relisting of the auction item in a new auction on the auction system is performed via at least one of:
an image recognition program to detect the use of images that accompanied a previously held auction; and
natural language text parsing programs to detect the use of similar descriptive information that accompanied the previously held auction.

2. The auction system of claim 1, wherein
the ownership of the auction item is recorded at a location associated with a distributed ledger system.

3. The auction system of claim 1, wherein, upon receival of a bid purchase, the instructions further cause the processing device to:
record at least one of identity, sale price, and transaction date of the bid purchase at a location associated with a distributed ledger system.

4. The auction system of claim 3, wherein
the location comprises a smart contract address.

5. The auction system of claim 1, wherein the instructions further cause the processing device to:
credit and debit the seller account and buyer accounts accordingly with a value based on the bid purchase.

6. The auction system of claim 1, wherein the instructions further cause the processing device to:
credit the buyer accounts with a value based on one of:
available promotional funds; and
additional promotional funds resulting from an increase in a house share.

7. The auction system of claim 1, wherein the instructions further cause the processing device to:
determine a creator fee; and
credit an original seller with the creator fee.

8. The auction system of claim 1, wherein the instructions further cause the processing device to:
determine a royalty fee; and
credit an original creator with the royalty fee
wherein
the original creator is not the seller.

9. The auction system of claim 1, wherein, upon the processing of each successive bid purchase, the instructions further cause the processing device to:
credit the seller account with a value based on the difference between a current bid purchase and a previous bid purchase.

10. An auction system to operate in conjunction with a plurality of participant devices corresponding to a plurality of participants, each participant device configured to receive auction information input by a participant and to display auction information to a participant, the auction information including a post of an auction item for sale by a participant at an initial selling price, and bid purchases from the plurality of participants, the auction system comprising:
memory storing executable instructions;
a processing device executing the instructions, wherein the instructions cause the processing device to:
process the auction information received from the plurality of participant devices to determine an instant profit value upon receiving a bid purchase from a participant or upon the satisfaction of an auction expiration condition, the instant profit value based on the value of the bid purchase;
manage participant accounts;
credit participant accounts with the instant profit value for the participants;
record ownership of the auction item to the participant that provides a bid purchase upon receiving the bid purchase from the participant;
process successive bid purchases for the auction item until an auction expiration condition is satisfied; and
wherein
the ownership of the auction item is recorded at a location associated with a distributed ledger system.

11. (canceled)

12. The auction system of claim 10, wherein, upon receival of a bid purchase, the auction system is further configured to
record at least one of identity, sale price, and transaction date of the bid purchase at a location associated with the distributed ledger system.

13. The auction system of claim 10, wherein the instructions further cause the processing device to:
credit the buyer accounts with a value based on one of:
available promotional funds; and
additional promotional funds resulting from an increase in a house share.

14. An auction method for selling an auction item for sale at an initial selling price, the method implemented on a computing device, the method comprising:
receiving bid purchases for the auction item from corresponding buyers over a network;
for each bid purchase received from the corresponding buyers or upon the satisfaction of an auction expiration condition:
determining an instant profit value based on the value of the bid purchase upon receiving the bid purchase at an auctioneer device;
crediting a corresponding buyer account with the instant profit value upon determining the instant profit value at the auctioneer device;
recording ownership of the auction item to the corresponding buyer upon determining the instant profit value at the auctioneer device;
processing successive bid purchases at the auctioneer device for the auction item until an auction expiration condition is satisfied,
record at least one of images that accompany the auction item and descriptive information that accompanies the auction item at a location associated with a distributed ledger system;
detect a relisting of the auction item in a new auction on the auction system; and
wherein
the detection of the relisting of the auction item in a new auction on the auction system is performed via at least one of:
an image recognition program to detect the use of images that accompanied a previously held auction; and
natural language text parsing programs to detect the use of similar descriptive information that accompanied the previously held auction.

15. The method of claim 14, wherein
the ownership of the auction item is recorded at a location associated with the distributed ledger system.

16. The method of claim 14, wherein,
upon receival of a bid purchase, at least one of identity, sale price, and transaction date of the bid purchase is recorded at a location associated with the distributed ledger system.

17. The method of claim 14, further comprising a step of:
crediting and debiting the seller account and buyer accounts accordingly with a value based on the bid purchase.

18. The method of claim 14, further comprising a step of:
crediting the buyer accounts with a value based on one of:
available promotional funds; and
additional promotional funds resulting from an increase in a house share.

19. The method of claim 14, further comprising steps of:
detecting a relisting of the auction item on the auction system;
determining a creator fee; and
crediting an original seller with the creator fee.

20. The auction system of claim 14, wherein the instructions further cause the processing device to:
determining a royalty fee; and
crediting an original creator with the royalty fee.
